(19) United States
(12) Patent Application Publication
(10) Pub. No.: US 2006/0133490 A1
(43) Pub. Date: Jun. 22, 2006

(54) Apparatus and method of encoding moving picture

(75) Inventors: Sung Ho Lee, Seoul (KR); Young Hooi Hwang, Seoul (KR); Woon Ki Park, Suwon-si (KR)

Correspondence Address: JONATHAN Y. KANG, ESQ.;LEE, HONG, DEGERMAN, KANG & SCHMADEKA, 14th Floor, 801 S. Figuaron Street, Los Angeles, CA, 90017, US

(73) Assignee: LG Electronics Inc.

(21) Appl. No.: 11/313,537

(22) Filed: Dec. 20, 2005

(30) Foreign Application Priority Data
Dec. 20, 2004 (KR) 10-2004-0108923

(51) Int. Cl. H04N 7/12; H04B 1/66; H04N 11/04; H04N 11/02

(52) U.S. Cl. 375/240.12; 375/240.29

(57) ABSTRACT

Provided are an apparatus and method of encoding a moving picture. An input original video signal is delayed and stored in a memory as a video signal for motion estimation (a video signal of a previous frame). Then, a motion estimation is performed using a video signal of a current frame and the reference image (the video signal of the previous frame). Accordingly, a decoding module/decoding processor for constructing a reference image in an existing encoder is eliminated.

This application claims the benefit of the Korean Patent Application Nos. 10-2004-0108923, filed on Dec. 20, 2004, which is hereby incorporated by reference herein in their entirety.

### BACKGROUND OF THE INVENTION

1. Field of the Invention

The present invention relates to an apparatus and method of encoding moving picture.

2. Description of the Related Art

Most of moving picture compression standards such as CODEC based on MPEG or H.26x employ a compression encoding scheme based on a motion estimation & compensation and transformation. Such an encoding based on the motion estimation & compensation has to encode a motion vector information of each block, and a compression efficiency greatly changes according to how to encode the motion vector.

According to a general process of encoding moving picture, a digital video signal is converted based on an orthogonal transform coding such as a discrete cosine transform (DCT), and a transform coefficient is quantized and a variable length coding (VLC) is performed on the quantized transform coefficient. Meanwhile, the quantized DCT coefficient is inverse-quantized and inverse-DCTed and then a decoded image is stored in a memory. A motion vector (MV) is calculated using the decoded image stored in the memory and a next frame image. The motion vector is VLCed. The VLCed motion vector and the encoded image information construct a bit stream.

A general coding method of a moving picture can be divided into a single image compression (intra coding, I frame encoding) and a motion estimation compression (inter coding, P frame encoding). The case of the moving picture widely uses a successive motion estimation compression scheme (inter coding) and periodically uses a single compression scheme (intra coding).

FIG. 1 is a block diagram of a related art apparatus of encoding a moving picture. Referring to FIG. 1, the related art apparatus of encoding the moving picture includes an encoding module 101 for encoding an input digital video signal, a buffer 102 for storing the encoded data, a decoding module 103 for decoding an output of the encoding module 101, a frame memory 104 for storing the decoded image outputted from the decoding module 103, and a motion estimator 105 for estimating a motion by referring to the decoded video signal stored in the frame memory 104 and the input digital video signal.

The encoding module 101 encodes the input digital video signal, the encoded data is stored in the buffer 102 and then outputted as a bit stream. The decoding module 103 decodes the encoded video signal to thereby recover the original video signal. The recovered video signal is stored in the frame memory 104. The motion estimator 105 performs the motion estimation by referring to the stored recovered video signal and the input digital video signal and outputs its result as a motion vector (MV).

FIG. 2 is a detailed block diagram of the related art apparatus of encoding the moving picture. The encoding module 210 includes an orthogonal transform coder 211, a quantizer 212, a run-length coder 213, a variable length coder 214, a multiplexer 215, and a coding controller 217. The decoding module 220 includes an inverse quantizer 221 and an orthogonal transform decoder 217. Also, the apparatus of encoding the moving picture includes the frame memory 224, the motion compensator 225, the motion estimator 226, the variable length coder 227, and the output buffer 216.

The orthogonal transform coder 211 performs an orthogonal transform coding, such as a DCT, on the digital video signal inputted in pixel block unit (e.g., 8×8). The quantizer 212 performs a quantization on the orthogonal-transform-coded data (e.g., DCT coefficient), and performs a compression by expressing the coded data with several representative values. The run-length coder 213 performs a run length coding (RLC) on the output of the quantizer 212. The variable length coder 214 performs a variable length coding (VLC) on the output of the run length coder 213 and inputs the VLCed data to the multiplexer 215.

The multiplexer 215 multiplexes the coded digital data and stores then in the buffer 216. The buffer 216 is used to construct the output bit stream. Also, a state of the buffer 216 is feed back to the coding controller 217 so as to properly control a bit rate according to a moving picture transmission environment. The coding controller 217 controls the bit rate by adjusting a quantization step.

Meanwhile, the output of the quantizer 212 is inversely quantized by the inverse quantizer 221 of the decoding module 220. The inversely quantized data is decoded through the orthogonal transform decoder 222. The decoded video signal is stored in the frame memory 224. The decoded video signal stored in the frame memory 224 is referred to video information of a previous frame.

The previous frame image stored in the frame memory 224 is motion-compensated by the motion compensator 225, and a difference signal between the motion-compensated video signal of the previous frame and the digital video signal of the current frame is provided to the orthogonal transform coder 211. Meanwhile, the motion estimator 226 calculates the motion vector (MV) for each macro block by using the digital video signal of the previous frame stored in the frame memory 224 and the digital video signal of the current frame. The variable length coder 227 receives the motion vector calculated by the motion estimator 226, removes a statistical overlap by performing a VLC on the motion vector, and provides it to the multiplexer 215.

The related art apparatus of FIGS. 1 and 2 has a very complex structure and requires high-performance hardware for processing large-capacity digital moving picture data fast and efficiently. For example, hardware that can compress a digital moving pictures having 24 frames per second with a size of QCIF (176×144) merely processes a digital moving picture with a CIF (352×288) size at a speed of 6 frames per second (about ¼ times).

The encoding apparatus includes various technologies for improving the compression performance. The reference image for motion estimation of the motion estimators 105 and 226 is generated through the decoding modules 103 and 220. Due to the decoding module, the structure of the encoding apparatus is more complex than the single compression encoding scheme. Accordingly, there is a demand for improving the complexity of the moving picture compression encoding scheme and the moving picture processability of the encoding apparatus.

In mobile terminals such as mobile phone with moving picture recording/playing function, portable multimedia player, and PDA, complex hardware acts as an obstruction factor in miniaturization and lightweight. Despite, such a mobile terminal requires high level of moving picture recording and playing. Therefore, there is a demand for a moving picture compression encoding technology that can be efficiently used in various terminals with moving picture processing function, including the mobile terminal.

### SUMMARY OF THE INVENTION

Accordingly, the present invention is directed to an apparatus and method of encoding a moving picture that substantially obviate one or more problems due to limitations and disadvantages of the related art.

An object of the present invention is to provide an apparatus and method of encoding a moving picture, capable of reducing a complexity of the moving picture encoder and maintaining a compatibility with an existing moving picture encoding standard technology.

An another object of the present invention is to provide an apparatus and method of encoding a moving picture, capable of reducing an encoding complexity and providing high level of a compression encoding performance by substituting an original video signal for a reference image for motion estimation and encoding and appropriately correcting the substituted original video signal through a processing such as an image filtering, whereby an existing decoding module/decoding processing is not required.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus of encoding a moving picture, including: an encoding part for compressing and coding a video signal; a video storing part for storing an inputted original video signal as a reference image for a motion estimation and encoding; and a motion estimation part for performing a motion estimation using the input video signal stored in the video storing part as a reference image for the motion estimator.

In another aspect of the present invention, there is provided an apparatus of encoding a moving picture, including: an encoding part for compressing and encoding a video signal; a video storing part for storing an original video signal of a previous frame as a reference image for a motion estimation and encoding of a video signal of a current frame; an image filter for filtering the video signal stored in the video storing part; and a motion estimation part for performing a motion estimation using the original video signal of the previous frame, which is stored in the video storing part, as the reference image for the motion estimation.

In a further another aspect of the present invention, there is provided a method of encoding a moving picture, including: compressing and encoding an input video signal; substituting the inputted original video signal for a decoded video signal of the encoded video signal and storing the substituted video signal as a reference image for an encoding of a next frame; performing a motion estimation using the stored original video signal of a previous frame as a reference image for a motion estimation; and providing the stored original video signal of the previous frame for compressing and encoding a video signal of a current frame, whereby a decoding module/decoding processor is eliminated by a process of substituting the original video signal for a decoded video signal.

Accordingly, the present invention can provide a compatibility with an existing moving picture encoder, reduce its complexity, and provide higher encoding performance than a low grade hardware. The present invention can be applied to high grade of mobile terminal and attribute to higher level of multimedia function than an existing high-quality moving picture recording and playing.

According to the present invention, a decoding module/process can be eliminated, and a motion compensation module/process is not used. Also, a high-performance moving compression encoding method is provided. Therefore, fast encoding performance can be secured under a low-performance hardware. Further, the present invention can be provided a real-time moving picture recording and/or replaying field of a mobile multimedia, thereby providing higher data processability.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a related art apparatus of encoding a moving picture;

FIG. 2 is a detailed block diagram of the encoding apparatus illustrated in FIG. 1;

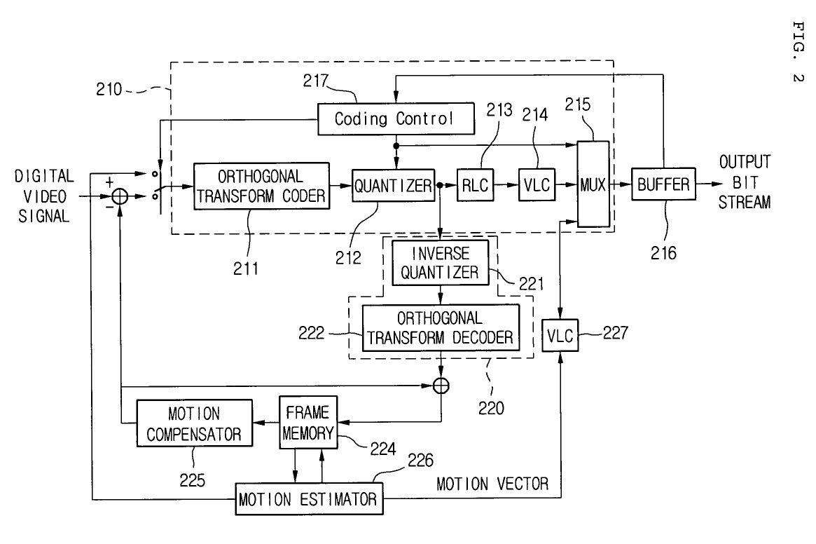

FIG. 3 is a block diagram of an apparatus of encoding a moving picture according to an embodiment of the present invention;

FIG. 4 is a detailed block diagram of the encoding apparatus illustrated in FIG. 3; and

FIG. 5 is a flowchart illustrating a method of encoding a moving picture according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

An apparatus of encoding a moving picture according to the present invention can be constructed with a simple structure by removing a decoding module/processor used for a motion estimation. Instead of an image decoded by an existing decoding module, an original image is stored in a frame memory.

According to the present invention, as an image referred to for the motion estimation and encoding, an incoming original image is stored in the decoded image and is used for the motion estimation and encoding, without using an image decoded through the decoding module/decoding processor.

Also, an incoming frame image is delayed by 1 frame and is stored in a reference region for the motion estimation and encoding in the frame memory (a previous frame image), and the motion estimation and encoding are performed using the current frame image and the reference image (previous frame image) stored in the memory.

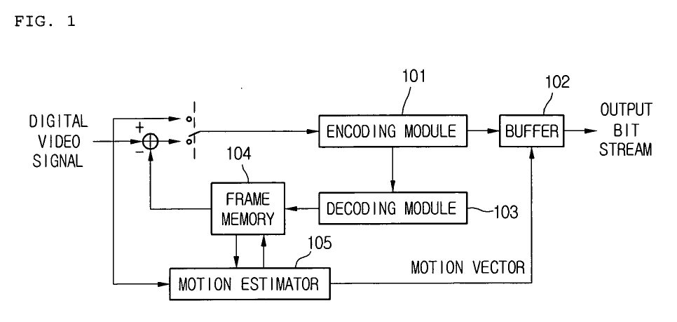

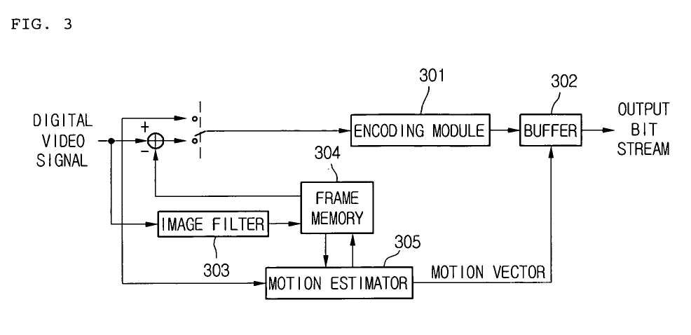

FIG. 3 is a block diagram of an apparatus of encoding a moving picture according to an embodiment of the present invention. Compared with the related art illustrated in FIG. 1, the decoding module is eliminated. Therefore, the complexity of the encoding apparatus is reduced. Since the decoding processor is eliminated, the encoding speed is higher than that of the related art.

Referring to FIG. 3, the encoding apparatus according to the present invention includes an encoding module 301 for sequentially performing an orthogonal transform coding, a quantization, an RLC, a VLC, and a bit stream construction with respect to an input digital video signal, a buffer 302 for storing an output of the encoding module 301, an image filter 303 for filtering the input digital video signal, a frame memory 304 for storing the incoming original video signal as a motion estimation reference image through the image filter, and a motion estimator 305 for performing a motion estimation using the stored video data of the frame memory and the inputted video signal.

The encoding module 301 performs a compression encoding on the inputted digital video signal. The encoding process is to sequentially perform an orthogonal transform coding, a quantization, an RLC, a VLC, and a bit stream construction. The bit stream that is compression-coded by the encoding module 301 is temporarily stored in the buffer 302 and is then outputted.

The frame memory 304 stores the original video signal, and the stored frame image is used in the motion estimation, in substitute for the decoded image outputted from the existing decoding module. That is, the frame memory 304 stores the original video signal as the motion estimation reference image corresponding to the existing decoding result.

When storing the original image as the motion estimation reference image, the unbalance between the encoder and decoder may degrade the image quality in the decoder. Also, because of the characteristic of a P frame, the degradation of the image quality is continuously accumulated as time passes by, thus degrading the entire codec performance. A localization process is used for suppressing the degradation of the image quality. The localization process used in the present invention prevents the accumulation of the degraded image quality by increasing the use frequency of I frame that does not undergo the motion estimation. For example, by encoding in a form of IPPPPPIPPPPPI, the image quality in the I frame interval can be enhanced up to the existing technical level.

The image filter 303 is disposed at an input terminal of the frame memory 304. The image filter 303 is provided for reducing the difference of pixel values when replacing the original image with an image corresponding to the existing decoding result, without using the decoding module. That is, since the present invention uses the replaced image without using the existing decoding module, there occurs a difference of pixel values between the image decoded by the existing decoding module and its replaced original image. Therefore, in order to reduce the difference of the pixel values, the input digital original image is appropriately corrected through the filtering.

The reference image of the existing encoder uses the image decoded within the encoder. Comparing this image with the 1-frame delayed image of the original signal, the decoded existing image is exhibited as a form where most of high frequency components are removed. Accordingly, the image filter may use a low pass filter (LPF). If the LPF is used as the image filter, most of the high frequency component is removed from the original image, so that the difference between the pixel values can be reduced. However, since the use of the filter may also impose a burden on hardware, the filter is designed to be selectively used according to situations. Also, the kind of the filter can be properly selected from the known filters.

In this embodiment, the input digital image can be directly stored in the frame memory 304. Also, as illustrated in FIG. 3, the input digital image can be stored in the frame memory 304 after passing through the image filter 303. The image filter 303 can be configured with an LPF or Gaussian two-dimensional filter.

For the frame image referred to in the motion estimation, the digital image inputted to the image filter 303 is delayed by 1 frame. Then, the digital image is appropriately corrected through the image filter and then stored in the frame memory 304. In another embodiment, while the original image is filtered in the image filter 303, it is delayed by 1 frame and stored in the frame memory 304.

The frame image stored in the frame memory 304 is provided to the encoding module 301. The motion estimator 305 performs the motion estimation using the stored motion estimation reference image of the frame memory 304 and the input digital image, and outputs its result as the motion vector.

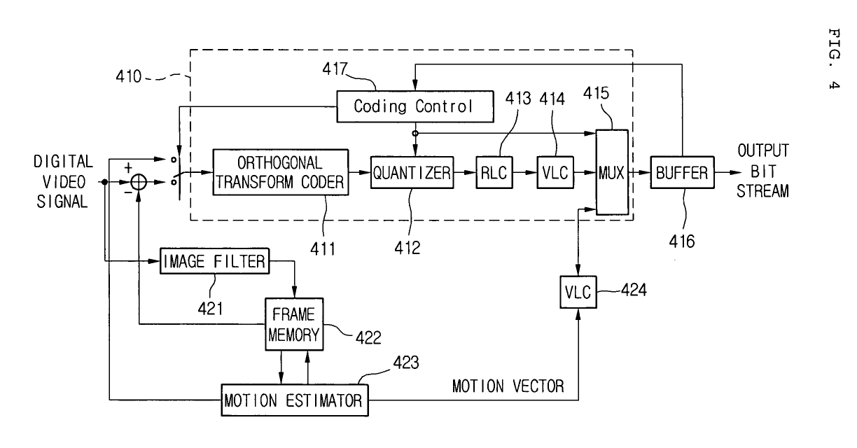

FIG. 4 is a detailed block diagram of the encoding apparatus according to the present invention.

Referring to FIG. 4, the encoding module 410 includes an orthogonal transform coder 411, a quantizer 412, a run-length coder 413, a variable length coder 414, a multiplexer 415, and a coding controller 417. Also, the encoding apparatus includes an image filter 412, a frame memory 422, a motion estimator 423, a variable length coder 424, and an output buffer 416.

The encoding module 410 performs a compression coding on an input digital video signal. The orthogonal transform coder 411 performs an orthogonal transform coding, such as a DCT, on the digital video signal inputted in pixel block unit (e.g., 8×8). The quantizer 412 performs a quantization on the orthogonal-transform-coded data (e.g., DCT coefficient), and performs a compression by expressing the coded data with several representative values. The run-length coder 413 performs a run length coding (RLC) on the output of the quantizer 412. The variable length coder 414 performs a variable length coding (VLC) on the output of the run length coder 413 and inputs the VLCed data to the multiplexer 415.

The multiplexer 415 multiplexes the coded digital data and stores then in the buffer 416. The buffer 416 is used to construct the output bit stream. Also, a state of the buffer 416 is feed back to the coding controller 417 so as to properly control a bit rate according to a moving picture transmission environment. The coding controller 417 controls the bit rate by adjusting a quantization step.

Meanwhile, the input digital video signal is corrected through the image filter 421 and is then stored in the frame memory 422. Here, the frame image stored in the frame memory 422 is corrected by the image filter 421 such that it becomes a motion estimation reference image corresponding to the existing decoding result.

That is, the image filter 421 corrects the original image so as to reduce difference of pixel values between the image frame recovered by the existing decoding module and its replaced original image. Also, the image filter 421 may not be used. Further, an LPF or Gaussian two-dimensional filter may be used as the image filter 421.

The image filter 421 corrects the frame image delayed by, for example, 1 frame, and the corrected frame image is stored in the frame memory 422. Therefore, the difference signal between the corrected frame image (1 frame delayed, previous frame image) from the frame memory 422 and the digital image of the current frame is provided to the orthogonal transform coder 411 of the encoding module 410. Also, the motion estimator 423 calculates the motion vector by referring to the motion estimation reference image stored in the frame memory 422 and the digital image of the current frame together, and the variable length coder 424 performs the VLC on the output of the motion estimator 423, and the output of the variable length coder 424 is inputted to the multiplexer 415. Since the original image is substituted for the motion estimation reference image, the motion compensator used in the existing encode is not required. The image stored in the frame memory 422 is directly transferred to the input terminal of the encoding module 410.

The motion estimator 423 calculates the motion vector (MV) for each macro block by using the digital video signal delayed by 1 frame and stored in the frame memory 422 (that is, the original video signal of the previous frame) and the digital video signal of the current frame. The variable length coder 424 receives the motion vector calculated by the motion estimator 423, removes a statistical overlap by performing a VLC on the motion vector, and provides it to the multiplexer 415. In this manner, it is used when constructing the bit stream of the frame compression coding data.

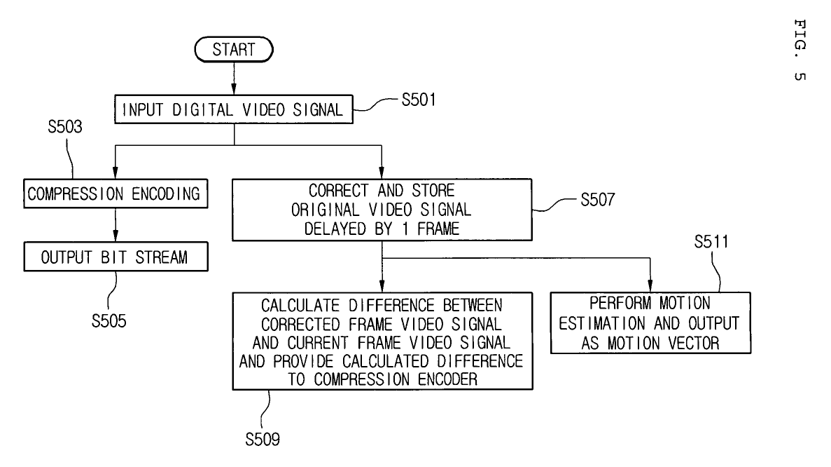

FIG. 5 is a flowchart illustrating a method of encoding a moving picture.

Referring to FIG. 5, a digital video signal is inputted (S501). The inputted digital video signal is compressed and coded through an orthogonal transform coding, quantization, RLC, and VLC by the encoding module (S503). The coded data is outputted a bit stream (S505).

Meanwhile, the original video signal is delayed by 1 frame, corrected by the image filter, and then stored in the frame memory (S507). The difference signal between the frame video signal stored in the frame memory and the image of the current frame is provided to the orthogonal transform coder of the encoding module (S509). The frame video signal stored in the frame memory is used for the motion estimation in the same manner as the decoded video signal stored in the frame memory of the existing encoder. Then, the bit stream is generated through the orthogonal transform coding, quantization, VLC, and so on.

The motion estimation is performed using the motion estimation reference image stored in the frame memory and the image of the current frame, and the motion vector is outputted (S511). The motion vector is multiplexed through the VLC, and is outputted together with the coded image data as the bit stream through the output buffer.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. An apparatus of encoding a moving picture, comprising:
an encoding part for compressing and coding a video signal;
a video storing part for storing an inputted original video signal as a reference image for a motion estimation and encoding; and
a motion estimation part for performing a motion estimation using the input video signal stored in the video storing part as a reference image for the motion estimator.

2. The apparatus according to claim 1, wherein the original video signal stored as the reference image is a video signal substituted for a video signal decoded by a decoding module/decoding processor.

3. The apparatus according to claim 1, wherein the stored input video signal is a video signal of a previous frame.

4. The apparatus according to claim 1, wherein the stored input video signal is a video signal of a previous frame, which is delayed by 1 frame.

5. The apparatus according to claim 1, further comprising an image filter for filtering the input video signal and storing the filtered video signal in the video storing part.

6. The apparatus according to claim 5, wherein the image filter is one of a low pass filter and a Gaussian two-dimensional filter.

7. The apparatus according to claim 1, further comprising an image filter for delaying the input video signal stored in the video storing part by 1 frame and filtering the delayed video signal.

8. The apparatus according to claim 7, wherein the image filter is one of a low pass filter and a Gaussian two-dimensional filter.

9. An apparatus of encoding a moving picture, comprising:
an encoding part for compressing and encoding a video signal;
a video storing part for storing an original video signal of a previous frame as a reference image for a motion estimation and encoding of a video signal of a current frame;
an image filter for filtering the video signal stored in the video storing part; and
a motion estimation part for performing a motion estimation using the original video signal of the previous frame, which is stored in the video storing part, as the reference image for the motion estimation.

10. The apparatus according to claim 9, wherein the video signal of the previous frame is a video signal delayed by 1 frame.

11. The apparatus according to claim 9, wherein the original video signal of the previous frame stored as the reference image is a video signal substituted for a video signal decoded by a decoding module/decoding processor.

12. The apparatus according to claim 9, wherein the image filter is one of a low pass filter and a Gaussian two-dimensional filter.

13. A method of encoding a moving picture, comprising:
compressing and encoding an input video signal;
substituting the inputted original video signal for a decoded video signal of the encoded video signal and storing the substituted video signal as a reference image for an encoding of a next frame;
performing a motion estimation using the stored original video signal of a previous frame as a reference image for a motion estimation; and
providing the stored original video signal of the previous frame for compressing and encoding a video signal of a current frame,
whereby a decoding module/decoding processor is eliminated by a process of substituting the original video signal for a decoded video signal.

14. The method according to claim 13, wherein the stored original video signal is a video signal of a previous frame, which is delayed 1 frame.

15. The method according to claim 13, further comprising filtering the original video signal to be stored as the reference image.

16. The method according to claim 13, further comprising low-pass-filtering the original video signal to be stored as the reference image.

17. The method according to claim 13, further comprising delaying the original video signal to be stored as the reference image by 1 frame, and filtering the delayed video signal.
